(19) United States
(12) Patent Application Publication
(10) Pub. No.: US 2020/0379872 A1
(43) Pub. Date: Dec. 3, 2020

(54) USER INTERFACE CONTROL DEVICE, USER INTERFACE CONTROL METHOD, AND RECORDING MEDIUM HAVING STORED THEREIN USER INTERFACE CONTROL PROGRAM

(71) Applicant: NEC Platforms, Ltd., Kawasaki-shi, Kanagawa (JP)

(72) Inventor: Junichi NAKAMURA, Kanagawa (JP)

(73) Assignee: NEC Platforms, Ltd., Kawasaki-shi, Kanagawa (JP)

(21) Appl. No.: 16/971,448

(22) PCT Filed: Feb. 19, 2019
(86) PCT No.: PCT/JP2019/005979

§ 371 Date: Aug. 20, 2020

(30) Foreign Application Priority Data
Feb. 27, 2018 (JP) 2018-033081

(51) Int. Cl. G06F 11/34; G06F 3/038

(52) U.S. Cl. CPC G06F 11/3476; G06F 3/038

(57) ABSTRACT

A user interface control device is for controlling a user interface related to a normal operation of an information processing apparatus configured such that a system management operation by firmware for controlling the information processing apparatus is controlled via an input manipulation performed on a management terminal device, the user interface control device including: an interface unit for receiving input information from an input device and inputting output information to an output device; a control unit for controlling a system management operation with use of the input information; and an input unit for inputting, to the interface unit, the output information that indicates a result of execution of the system management operation, to enhance the efficiency of system management work in the information processing apparatus configured such that a system management operation by the firmware is controlled via an input manipulation performed on the management terminal device.

### TECHNICAL FIELD

The invention of the present application relates to a technique for controlling a user interface relating to a system management function provided by firmware controlling an information processing device.

### BACKGROUND ART

In a highly information-oriented modern society, expectation of a technique that achieves more efficient performance of system management including, for example, collection or the like of a log, relating to an information processing device providing various services is becoming increasingly high.

As a technique concerning such a technique, PTL 1 discloses electronic equipment provided in such a way that a log can be recorded and output to outside after reactivation, without constantly securing, in an internal non-volatile memory, an area for recording the log. When a predetermined error occurs, the electronic equipment generates a log, writes the log into a program area, changes an activation mode from a normal mode to a log collection mode, and then reactivates the own equipment. When the activation mode is the log collection mode at activation of the own equipment, the electronic equipment reads a log from the program area, and outputs the read log to an external device.

PTL 2 discloses a server provided in such a way that embedded firmware easily detects a failure by saving information to be displayed on a console. In this server, when a failure occurs, the embedded firmware saves, in a memory for dump provided in the server, failure information such as an operating system (OS) dump message to be output to the console, and outputs the failure information to a terminal device.

PTL 3 relates to a data input processing scheme in which a user selects menu-displayed key information, and thereby, data relevant to the key information are input from a database, and discloses the data input processing scheme which does not cause trouble in menu selection even when the database is large. This scheme includes a console having a display unit and an operation unit, a database storing data relevant to a position retrieved by using key information, and an index file in which key information targeted at a specific group is registered. In the scheme, key information in the index file is menu-displayed, a user selects the key information, and thereby, relevant data are input from the database. In the scheme, key information registered in the index file is updated by being rearranged in an order of sorting according to the number of use counts of the key information, and key information of newly used data in the database is automatically added and registered. An index file in the scheme is provided for each user.

### CITATION LIST

### Patent Literature

[PTL 1] Japanese Unexamined Patent Application Publication No. 2016-139206

[PTL 2] Japanese Unexamined Patent Application Publication No. 2014-153793

[PTL 3] Japanese Unexamined Patent Application Publication No. H05-046337

### SUMMARY OF INVENTION

### Technical Problem

A highly functional and large-sized server device or the like includes a high-level system management function. Therefore, such a server device is generally configured in such a way that a system management operation by firmware is controlled via an input manipulation on a management terminal device connected to the server device via a dedicated interface (dedicated port) for system management. When, for example, a failure occurs in such a large-sized server device or the like, a maintenance worker for the server device needs to perform work such as collection of a log, by carrying the management terminal device into a customer's place where the server device is installed, and connecting the management terminal device to the server device.

However, depending on a customer's place, carrying in of an information processing device such as a management terminal device may be restricted due to a problem of security or the like. Depending on an environment of a place where a server device is installed, cable connection between a dedicated interface for system management and a management terminal device may cause trouble. Depending on an environment of a place where a server device is installed, there may be a need to temporarily stop running of the server device at the cable connection.

Specifically, in relation to an information processing device such as a large-sized server device configured in such a way that a system management operation by firmware is controlled via an input manipulation on a management terminal device, it may be difficult to efficiently perform system management work, depending on an environment of a place where the server device is installed, or the like. PTLs 1 to 3 do not mention such a problem. A main object of the invention of the present application is to provide a user interface control device and the like that solve the problem.

### Solution to Problem

A user interface control device according to one aspect of the invention of the present application is a device controlling a user interface relating to a normal operation by an information processing device configured in such a way that a system management operation by firmware controlling the information processing device is controlled via an input manipulation on a management terminal device connected to the information processing device, and the user interface control device includes: an interface means for receiving input information from an input device connected to the information processing device, and inputting output information to an output device connected to the information processing device; a control means for controlling the system management operation by the firmware with use of the input information; and an input means for inputting, to the interface means, the output information representing a result of execution of the system management operation by the firmware.

In another perspective of accomplishing the above-described object, a user interface control method according to one aspect of the invention of the present application includes: by a second information processing device controlling a user interface relating to a normal operation by a first information processing device configured in such a way that a system management operation by firmware controlling the first information processing device is controlled via an input manipulation on a management terminal device connected to the first information processing device, receiving input information from an input device connected to the first information processing device; controlling the system management operation by the firmware with use of the input information; and inputting, to an output device connected to the first information processing device, output information representing a result of execution of the system management operation by the firmware.

In still another perspective of accomplishing the above-described object, a user interface control program according to one aspect of the invention of the present application causes a computer controlling a user interface relating to a normal operation by an information processing device configured in such a way that a system management operation by firmware controlling the information processing device is controlled via an input manipulation on a management terminal device connected to the information processing device, to achieve: interface processing of receiving input information from an input device connected to the information processing device, and inputting output information to an output device connected to the information processing device; control processing of controlling the system management operation by the firmware with use of the input information; and input processing of inputting, to the interface processing, the output information representing a result of execution of the system management operation by the firmware.

Furthermore, the invention of the present application is also achievable by a computer-readable non-volatile recording medium storing the user interface control program (computer program).

### Advantageous Effects of Invention

The invention of the present application enables efficient performance of system management work, in relation to an information processing device configured in such a way that a system management operation by firmware controlling the information processing device is controlled via an input manipulation on a management terminal device.

### BRIEF DESCRIPTION OF DRAWINGS

FIG. 1 is a block diagram conceptually illustrating a configuration of a blade server system 1 according to a first example embodiment of the invention of the present application.

FIG. 2 is a diagram exemplifying an aspect (first state) of an OSD menu screen displayed on a display 23 by a user interface control device 100 according to the first example embodiment of the invention of the present application.

FIG. 3 is a diagram exemplifying an aspect (second state) of an OSD menu screen displayed on the display 23 by the user interface control device 100 according to the first example embodiment of the invention of the present application.

FIG. 4 is a diagram exemplifying an aspect (third state) of an OSD menu screen displayed on the display 23 by the user interface control device 100 according to the first example embodiment of the invention of the present application.

FIG. 5 is a diagram exemplifying an aspect (fourth state) of an OSD menu screen displayed on the display 23 by the user interface control device 100 according to the first example embodiment of the invention of the present application.

FIG. 6 is a flowchart illustrating an operation of the user interface control device 100 according to the first example embodiment of the invention of the present application.

FIG. 7 is a block diagram conceptually illustrating a configuration of a user interface control device 400 according to a second example embodiment of the invention of the present application.

FIG. 8 is a block diagram illustrating a configuration of an information processing device 900 being capable of executing the user interface control device according to each of the example embodiments of the invention of the present application.

### EXAMPLE EMBODIMENT

Hereinafter, example embodiments of the invention of the present application will be described in detail with reference to the drawings.

### First Example Embodiment

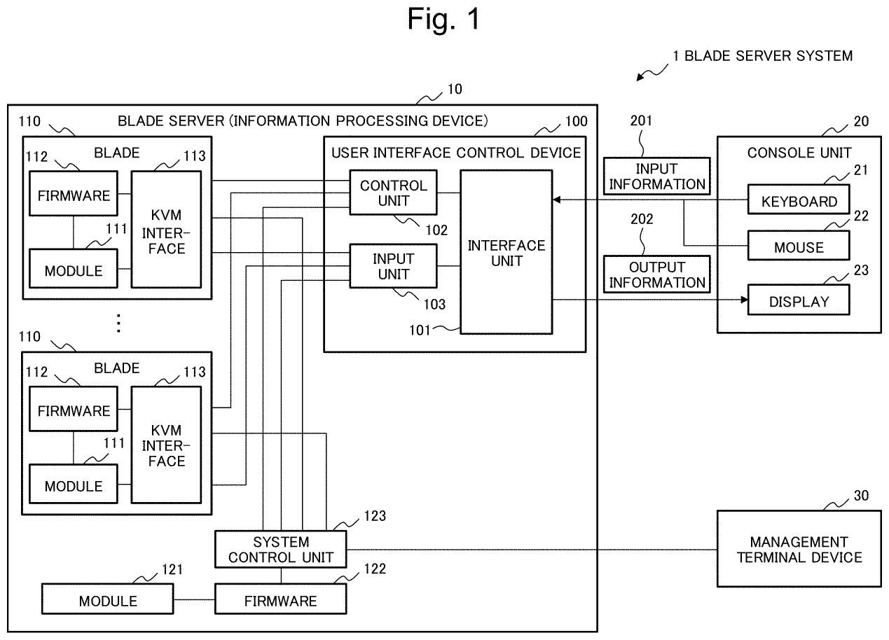

FIG. 1 is a block diagram conceptually illustrating a configuration of a blade server system 1 according to a first example embodiment of the invention of the present application. The blade server system 1 according to the present example embodiment broadly includes a blade server (information processing device) 10, a console unit 20, and a management terminal device 30. Although the information processing device according to the present example embodiment is a blade server, the information processing device is not limited to the blade server, and may be an information processing device other than the blade server.

The console unit 20 is a device that achieves a user interface relating to a normal operation and a system management operation by the blade server 10. Note that, the normal operation refers to an operation (i.e. an operation in a normal running state) in which the blade server 10 executes an application providing various services to a user, for example, under an environment where an OS is executed. The system management operation is, for example, an operation of collecting a log in the blade server 10, an operation of changing setting relating to a configuration or the like of the blade server 10 (i.e. an operation performed in maintenance work or the like), or the like.

The console unit 20 includes a keyboard 21, a mouse 22, and a display 23. The console unit 20 may include an input/output device differing from the keyboard 21, the mouse 22, and the display 23. The console unit 20 inputs input information 201 input-manipulated by the user with use of the keyboard 21 or the mouse 22, to a later-described user interface control device 100 in the blade server 10. The console unit 20 displays, on the display 23, output information 202 output from the user interface control device 100.

The management terminal device 30 is a terminal device, such as a personal computer or the like, that the user uses when executing the system management operation by the blade server 10. Note that, the management terminal device 30 is communicably connected to a later-described system control unit 123 in the blade server 10 via a dedicated interface (dedicated port) for system management. The management terminal device 30 inputs information input by a manipulation of the user to the system control unit 123. The management terminal device 30 displays, on a display (not illustrated) included in the management terminal device 30, information output from the system control unit 123.

The blade server 10 includes the user interface control device 100, one or more blades 110, a module 121, firmware 122, and the system control unit 123.

The one or more blades 110 each constitute a single information processing device, and include a module 111, firmware 112, and a keyboard, video and mouse (KVM) interface 113.

The module 111 includes a component, such as a central processing unit (CPU), a memory, and the like, necessary for the blade 110 to function as an information processing device. The firmware 112 controls the blade 110, and is stored in, for example, a memory or the like in the module 111. The KVM interface 113 controls input of information to the blade 110, and output of information from the blade 110.

The module 121 includes a configuration necessary for a housing in which the one or more blades 110 are mounted, and includes, for example, a memory, a configuration that controls a communication between the blades 110, a cooling device such as a fan, and the like. The firmware 122 controls the whole blade server 10, and is stored in, for example, a memory or the like in the module 121.

The system control unit 123 controls a system management operation relating to the blade server 10, by controlling the firmware 112 or the firmware 122, based on the input information 201 input from the later-described user interface control device 100, or information input to the management terminal device 30 by a manipulation of the user.

The user interface control device 100 includes an interface unit 101, a control unit 102, and an input unit 103.

The input information 201 is input to the interface unit 101 from the console unit 20. The interface unit 101 inputs the input input information 201 to the later-described control unit 102. The output information 202 is also input to the interface unit 101 from the later-described input unit 103. The interface unit 101 inputs the input output information 202 to the console unit 20.

The control unit 102 controls processing relating to system management by the firmware 112 via, for example, a serial port communicably connecting the user interface control device 100 and the blade 110 with use of the input information 201 input from the interface unit 101. The user interface control device 100 and the blade 110 may be communicably connected to each other by, for example, a system management (SM) bus, a peripheral component interconnect (PCI) bus, or the like. The control unit 102 also controls processing relating to system management by the firmware 122 via the system control unit 123 with use of the input information 201 input from the interface unit 101.

The input unit 103 inputs, to the interface unit 101, the output information 202 representing a result of execution of the processing relating to system management by the firmware 112 or the firmware 122 under control based on the input information 201 by the control unit 102.

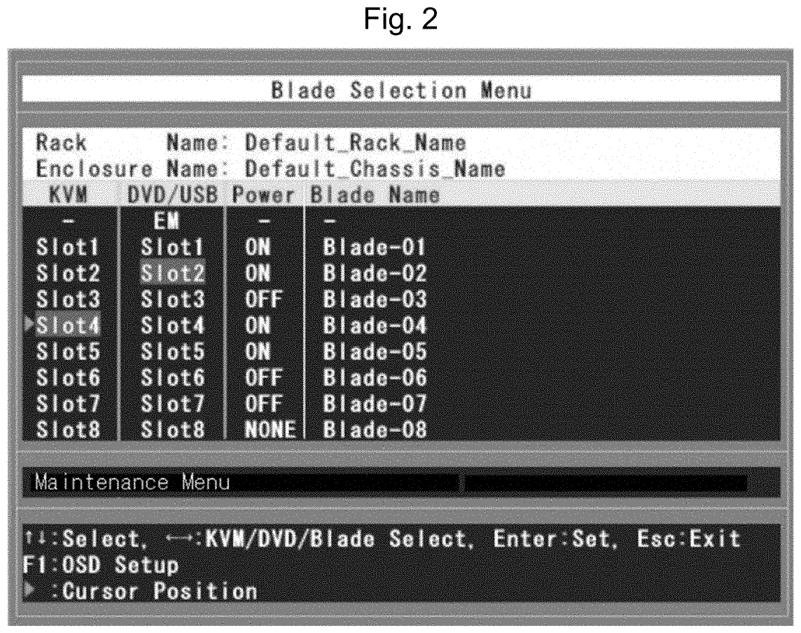

Next, examples of aspects (first to fourth states) of an on screen display (OSD) menu screen relating to system management and being displayed on the display 23 in the console unit 20 by the user interface control device 100 according to the present example embodiment are described with reference to FIGS. 2 to 5. It is also possible that the OSD menu screen exemplified in FIGS. 2 to 5 is displayed by the management terminal device 30 on a display included in the management terminal device 30.

FIG. 2 is a diagram exemplifying an aspect of an OSD menu screen (first state) that the user interface control device 100 displays on the display 23 by controlling the firmware 122, based on the input information 201 instructing to display an OSD menu screen. The user selects, for example, a maintenance menu by using the keyboard 21 or the mouse 22, in a state where the OSD menu screen exemplified in FIG. 2 is displayed on the display 23.

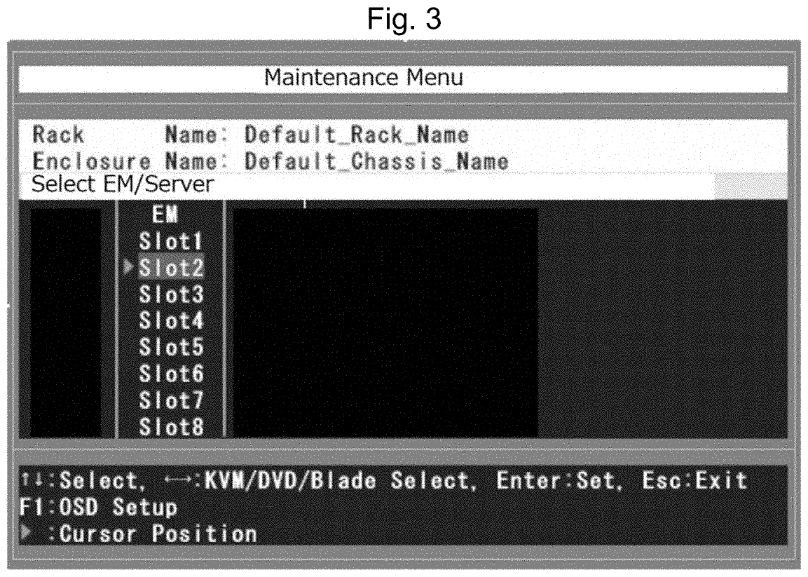

FIG. 3 is a diagram exemplifying an aspect of an OSD menu screen (second state) that the user interface control device 100 displays on the display 23 by the above-described input manipulation by the user, in a state where the OSD menu screen exemplified in FIG. 2 is displayed on the display 23. A maintenance menu screen exemplified in FIG. 3 is a screen for selecting the blade 110 targeted for performing a system management operation. In the example illustrated in FIG. 3, the user selects the blade 110 mounted in a slot 2 in the blade server 10.

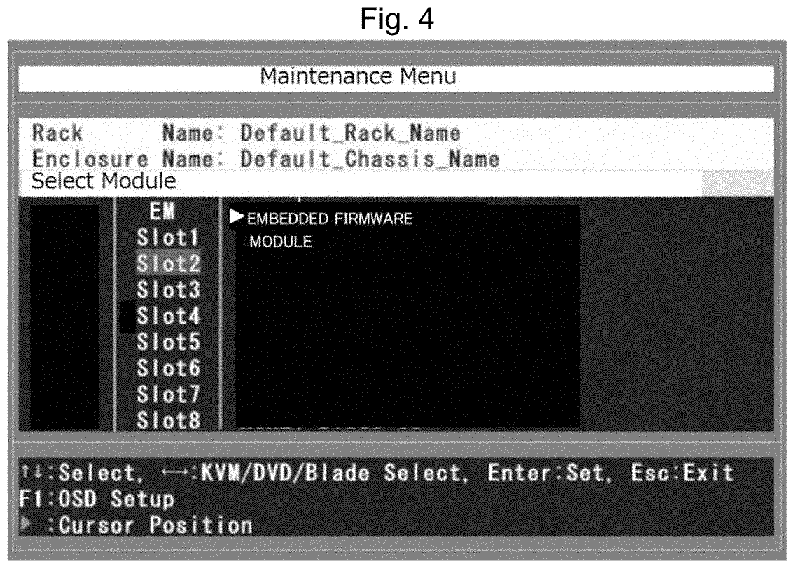

FIG. 4 is a diagram exemplifying an aspect of an OSD menu screen (third state) that the user interface control device 100 displays on the display 23 by the above-described input manipulation by the user, in a state where the OSD menu screen exemplified in FIG. 3 is displayed on the display 23. A maintenance menu screen exemplified in FIG. 4 is a screen for selecting whether a target for accessing is the firmware 112 or the module 111 (a configuration management function and the like included in the module 111 itself), with regard to the blade 110 mounted in the slot 2 selected by the user. In the example illustrated in FIG. 4, the user selects the firmware 112 in the blade 110 mounted in the slot 2.

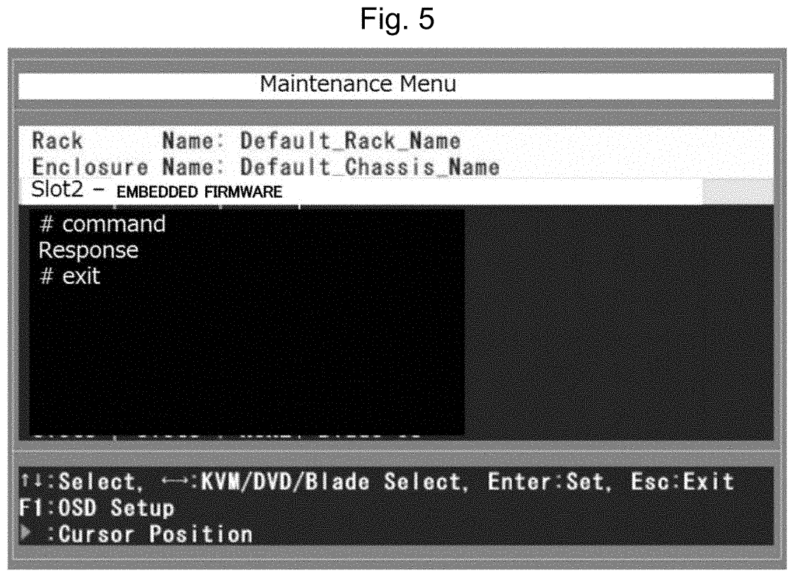

FIG. 5 is a diagram exemplifying an aspect of an OSD menu screen (fourth state) that the user interface control device 100 displays on the display 23 by the above-described input manipulation by the user, in a state where the OSD menu screen exemplified in FIG. 4 is displayed on the display 23. A maintenance menu screen exemplified in FIG. 5 represents that, for example, a command for collecting a log input by the user to the firmware 112 of the blade 110 mounted in the slot 2 selected by the user is executed.

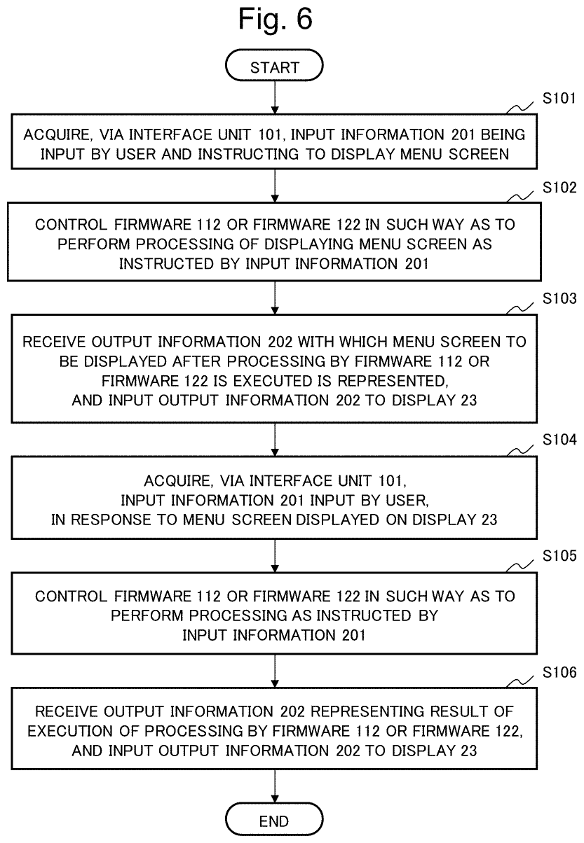

Next, an operation (processing) of the user interface control device 100 according to the present example embodiment is described in detail with reference to a flowchart in FIG. 6.

The control unit 102 acquires, via the interface unit 101, the input information 201 being input by the user and instructing to display a menu screen (step S101). The control unit 102 controls the firmware 112 or the firmware 122 in such a way as to perform processing of displaying the menu screen as instructed by the input information 201 (step S102). The input unit 103 receives output information 202 with which a menu screen to be displayed after the processing by the firmware 112 or the firmware 122 is executed is represented, and the input unit 103 inputs the output information 202 to the display 23 (step S103).

The control unit 102 acquires, via the interface unit 101, the input information 201 input by the user, in response to a menu screen represented by the output information 202 displayed on the display 23 (step S104). The control unit 102 controls the firmware 112 or the firmware 122 in such a way as to perform processing (e.g. processing of collecting a log, or the like) as instructed by the input information 201 (step S105). The input unit 103 receives the output information 202 representing a result of execution of the processing by the firmware 112 or the firmware 122, and inputs the output information 202 to the display 23 (step S106), and overall processing ends.

The user interface control device 100 according to the present example embodiment allows the user to efficiently perform system management work in relation to an information processing device configured in such a way that a system management operation by firmware controlling the information processing device is controlled via an input manipulation on the management terminal device. A reason for this is that the user interface control device 100 controls a user interface relating to a normal operation by the blade server (information processing device) 10, and also controls a user interface relating to a system management operation by the blade server 10.

An advantageous effect achieved by the user interface control device 100 according to the present example embodiment is described in detail below.

A large-sized server device or the like including a high-level system management function is generally configured in such a way that a system management operation by firmware is controlled via an input manipulation on a management terminal device connected to the server device via a dedicated interface (dedicated port) for system management. When, for example, a failure occurs in such a large-sized server device or the like, a maintenance worker of the server device needs to perform work such as collection of a log, by carrying the management terminal device into a customer's place where the server device is installed, and connecting the management terminal device to the server device.

However, depending on a customer's place, carrying in of an information processing device such as a management terminal device may be restricted due to a problem of security or the like. Alternatively, depending on an environment of a place where a server device is installed, cable connection between a dedicated interface for system management and a management terminal device may cause trouble. Specifically, in relation to such an information processing device as a large-sized server device, it may be difficult to efficiently perform system management work.

For such a problem, the user interface control device 100 according to the present example embodiment includes the interface unit 101, the control unit 102, and the input unit 103, and operates as described above with reference to, for example, FIGS. 1 to 6. Specifically, the user interface control device 100 is a device that controls a user interface relating to a normal operation by the blade server 10. Note that, the blade server 10 is a device configured in such a way that a system management operation by the firmware 112 or 122 controlling the blade server 10 is controlled via an input manipulation on the management terminal device 30 connected to the blade server 10.

In such an environment, the interface unit 101 receives the input information 201 from the console unit 20 connected to the blade server 10, and inputs the output information 202 to the console unit 20. The control unit 102 controls a system management operation by the firmware 112 or 122 with use of the input information 201. The input unit 103 inputs, to the interface unit 101, the output information 202 representing a result of execution of the system management operation by the firmware 112 or 122.

Thus, the user interface control device 100 according to the present example embodiment builds a user interface relating to a system management operation, by using the console unit 20 being a user interface relating to a normal operation, without using the management terminal device 30, in, for example, an environment where it is difficult to connect the management terminal device 30 to the blade server 10. Specifically, the user interface control device 100 according to the present example embodiment can enhance flexibility of a user interface relating to a system management operation, in an information processing device configured in such a way that a system management operation by firmware controlling the information processing device is controlled via an input manipulation on a management terminal device.

The control unit 102 according to the present example embodiment may select one of the input information 201, and information input from the management terminal device 30, and control a system management operation by the firmware 112 or 122, with use of the selected information. The input unit 103 may input the output information 202 to the console unit 20 via the interface unit 101, and input the output information 202 to the management terminal device 30 via the system control unit 123. Specifically, in this case, the user interface control device 100 builds two systems of user interfaces (the console unit 20 and the management terminal device 30) relating to a system management operation. Thus, the user interface control device 100 according to the present example embodiment can increase efficiency of, for example, work by a plurality of maintenance workers.

### Second Example Embodiment

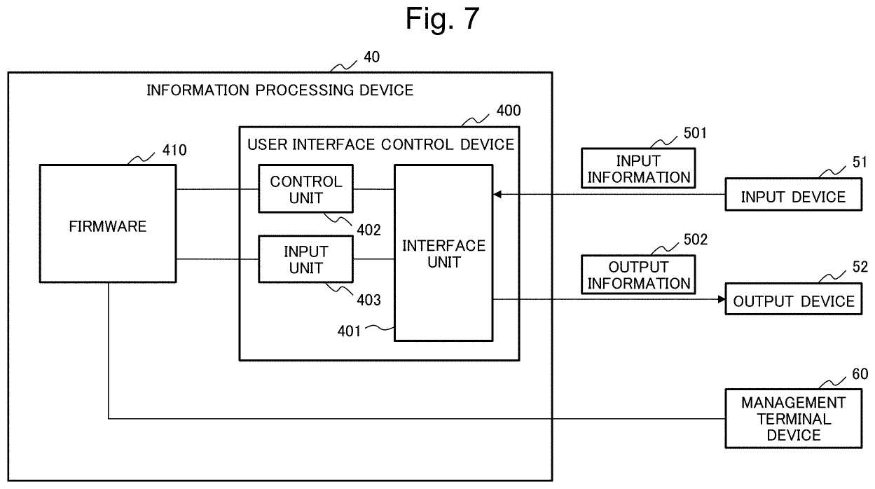

FIG. 7 is a block diagram conceptually illustrating a configuration of a user interface control device 400 according to a second example embodiment of the invention of the present application.

The user interface control device 400 is a device controlling a user interface relating to a normal operation by an information processing device 40 configured in such a way that a system management operation by firmware 410 controlling the information processing device 40 is controlled via an input manipulation on a management terminal device 60 connected to the information processing device 40.

The user interface control device 400 according to the present example embodiment includes an interface unit 401, a control unit 402, and an input unit 403.

The interface unit 401 receives input information 501 from an input device 51 connected to the information processing device 40, and inputs output information 502 to an output device 52 connected to the information processing device 40.

The control unit 402 controls a system management operation by the firmware 410 with the use of the input information 501.

The input unit 403 inputs, to the interface unit 401, the output information 502 representing a result of execution of the system management operation by the firmware 410.

The user interface control device 400 according to the present example embodiment allows the user to efficiently perform system management work in relation to an information processing device configured in such a way that a system management operation by firmware controlling the information processing device is controlled via an input manipulation on the management terminal device. A reason for this is that the user interface control device 400 controls a user interface relating to a normal operation by the information processing device 40, and also controls a user interface relating to a system management operation by the information processing device 40.

### Hardware Configuration Example

Each unit in each of the user interface control devices illustrated in FIGS. 1 and 7 in each of the example embodiments described above may be achieved by dedicated hardware (HW) (an electronic circuit). In FIGS. 1 and 7, at least the following components may be each regarded as a functional (processing) unit (software module) of a software program.
Interface units 101 and 401,
Control units 102 and 402, and
Input units 103 and 403.

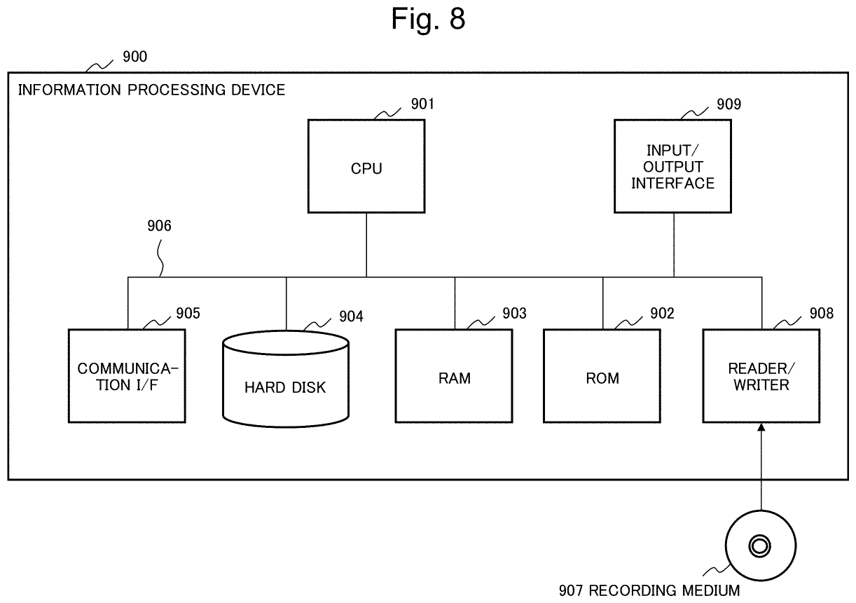

Classification of each unit illustrated in the drawings is a configuration for convenience of description, and various configurations are conceivable at implementation. One example of a hardware environment in this case is described with reference to FIG. 8.

FIG. 8 is a diagram exemplarily illustrating a configuration of an information processing device 900 (computer) being capable of executing the user interface control device according to each of the example embodiments of the invention of the present application. Specifically, FIG. 8 represents a hardware environment that is a configuration of a computer (information processing device) being capable of achieving the user interface control devices illustrated in FIGS. 1 and 7, and that is capable of achieving each function in the example embodiments described above.

The information processing device 900 illustrated in FIG. 8 includes the following as components.
A central processing unit (CPU) 901,
A read only memory (ROM) 902,
A random access memory (RAM) 903,
A hard disk (storage device) 904,
A communication interface 905,
A bus 906 (communication wire),
A reader/writer 908 being capable of reading and writing data stored in a recording medium 907 such as a compact disc read only memory (CD-ROM), and
An input/output interface 909 functioning as the keyboard 21, the mouse 22, and the display 23 illustrated in FIG. 1, and the input device 51 and the output device 52 illustrated in FIG. 7.

Specifically, the information processing device 900 including the components described above is a general computer in which the components are connected via the bus 906. The information processing device 900 may include a plurality of the CPUs 901, or may include the multi-core CPU 901.

The invention of the present application described with the above example embodiments as examples supplies a computer program being capable of achieving the following function to the information processing device 900 illustrated in FIG. 8. The function is a function of the above-described configuration in the block configuration diagram (FIGS. 1 and 7) referred to in the description of the example embodiments, or the flowchart (FIG. 6). The invention of the present application is achieved by then reading the computer program into the CPU 901 of the hardware, and interpreting and executing the computer program. The computer program supplied into the device may be stored in a readable/writable volatile memory (RAM 903) or a non-volatile storage device such as the ROM 902, the hard disk 904, or the like.

In the case described above, a procedure that is common at present may be adopted as a method of supplying a computer program into the hardware. As the procedure, there are, for example, a method of installing a program into the device via the various recording media 907 such as a CD-ROM and the like, a method of downloading a program from outside via a communication line such as the Internet, and the like. In such a case, the invention of the present application may be regarded as being configured by a code constituting the computer program, or the recording medium 907 storing the code.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2018-033081, filed on Feb. 27, 2018, the disclosure of which is incorporated herein in its entirety by reference.

### REFERENCE SIGNS LIST

1 Blade server system

10 Blade server

100 User interface control device

101 Interface unit

102 Control unit

103 Input unit

110 Blade

111 Module

112 Firmware

113 KVM interface

121 Module

122 Firmware

123 System control unit

20 Console unit

21 Keyboard

22 Mouse

23 Display

201 Input information

202 Output information

30 Management terminal device

40 Information processing device

400 User interface control device

401 Interface unit

402 Control unit

403 Input unit

410 Firmware

51 Input device

501 Input information

52 Output device

502 Output information

60 Management terminal device

900 Information processing device

901 CPU

902 ROM

903 RAM

904 Hard disk (storage device)

905 Communication interface

906 Bus

907 Recording medium

908 Reader/writer

909 Input/output interface

What is claimed is:

1. A user interface control device controlling a user interface relating to a normal operation by an information processing device configured in such a way that a system management operation by firmware controlling the information processing device is controlled via an input manipulation on a management terminal device connected to the information processing device, the user interface control device comprising:
at least one memory storing a computer program; and
at least one processor configured to execute the computer program to:
receive input information from an input device connected to the information processing device, and inputting output information to an output device connected to the information processing device;
control the system management operation by the firmware with use of the input information; and
input, to the processor, the output information representing a result of execution of the system management operation by the firmware.

2. The user interface control device according to claim 1, wherein the processor is configured to execute the computer program to:
receive the input information instructing to gather a log relating to the information processing device, and inputs, to the output device, the output information representing that gathering of the log is executed;
control the system management operation of gathering the log by the firmware; and
input, to the processor, the output information representing that gathering of the log is executed.

3. The user interface control device according to claim 1, wherein
the information processing device is a blade server mounted with one or more blades, and
the processor is configured to execute the computer program to:
input, to the output device, the output information representing a selection screen used when a user selects a specific one of the blades targeted for processing by the firmware;
receive the input information representing the specific blade selected by the user; and
control the system management operation for the specific blade by the firmware.

4. The user interface control device according to claim 1, wherein the processor is configured to execute the computer program to:
control the system management operation by the firmware, with use of one of the input information and information input from the management terminal device; and
input the output information to the processor and the management terminal device.

5. The user interface control device according to claim 1, wherein the processor is configured to execute the computer program to
input and output the input information or the output information via a serial port, a system management (SM) bus, or a peripheral component interconnect (PCI) bus.

6. The user interface control device according to claim 1, wherein
the input device is a keyboard or a mouse, and
the output device is a display.

7. A user interface control method comprising,
by a second information processing device controlling a user interface relating to a normal operation by a first information processing device configured in such a way that a system management operation by firmware controlling the first information processing device is controlled via an input manipulation on a management terminal device connected to the first information processing device:
receiving input information from an input device connected to the first information processing device;
controlling the system management operation by the firmware with use of the input information; and
inputting, to an output device connected to the first information processing device, output information representing a result of execution of the system management operation by the firmware.

8. The user interface control method according to claim 7, further comprising,
by the second information processing device:
receiving the input information instructing to gather a log relating to the first information processing device;
controlling the system management operation of gathering the log by the firmware, and
inputting, to the output device, the output information representing that gathering of the log is executed.

9. A non-transitory computer-readable recording medium storing a user interface control program that causes a computer controlling a user interface relating to a normal operation by an information processing device configured in such a way that a system management operation by firmware controlling the information processing device is controlled via an input manipulation on a management terminal device connected to the information processing device, to execute:
interface processing of receiving input information from an input device connected to the information processing device, and inputting output information to an output device connected to the information processing device;
control processing of controlling the system management operation by the firmware with use of the input information; and
input processing of inputting, to the interface processing, the output information representing a result of execution of the system management operation by the firmware.

10. The recording medium storing the user interface control program according to claim 9, wherein
the interface processing receives the input information instructing to gather a log relating to the information processing device, and inputs, to the output device, the output information representing that gathering of the log is executed,
the control processing controls the system management operation of gathering the log by the firmware, and
the input processing inputs, to the interface processing, the output information representing that gathering of the log is executed.
